(19) United States
(12) Patent Application Publication
(10) Pub. No.: US 2012/0145488 A1
(43) Pub. Date: Jun. 14, 2012

(54) ELEVATOR OPERATING APPARATUS

(75) Inventor: Hidenobu Nakashima, Aichi (JP)

(73) Assignee: Mitsubishi Electric Corporation, Tokyo (JP)

(21) Appl. No.: 13/391,873

(22) PCT Filed: Oct. 23, 2009
(86) PCT No.: PCT/JP09/68242

§ 371 Date: Feb. 23, 2012

(51) Int. Cl. B66B 1/22

(52) U.S. Cl. 187/389

(57) ABSTRACT

An elevator operating apparatus including a destination floor reservation device. The destination floor reservation device is placed distant from an elevator hall so that the user can register personal information and destination floor from the destination floor reservation device before getting on an elevator car. An input device for the user to input the personal information is installed at the elevator hall. When the destination floor is registered from the destination floor reservation device, the elevator car is arranged at the boarding floor. After the elevator car has been arranged at the boarding floor, during the time when a person having not inputted the personal information from the input device is present among the users having registered the personal information from the destination floor reservation device, the elevator car is caused to wait at the boarding floor while the door thereof is open.

### TECHNICAL FIELD

The present invention relates to an elevator operating apparatus in which a user registers his/her destination floor before he/she gets on an elevator car.

### BACKGROUND ART

Some elevators are configured so that a user can register his/her destination floor before he/she gets on a car. For the elevators of this type, if a destination floor reservation device for registering a destination floor is installed at a place distant from an elevator hall, the user must move on foot to the hall after having registered the destination floor, and therefore the elevator door is sometimes closed before the user arrives at the hall (before the user gets on the elevator car).

Patent Literature 1 describes an elevator apparatus which group-controls a plurality of elevators. In this apparatus, the door opening time at a boarding floor is changed according to the distance between a hall button and an elevator assigned to a call.

Also, Patent Literature 2 describes an elevator apparatus in which a destination floor is registered based on authentication performed by using a security system for a building, and the door closing operation is started when the user performs an authenticating operation again in the car.

### CITATION LIST

### Patent Literature

Patent Literature 1: Japanese Patent Laid-Open No. 2000-16729
Patent Literature 2: Japanese Patent Laid-Open No. 2005-324889

### SUMMARY OF INVENTION

### Technical Problem

For the elevator provided with the aforementioned destination floor reservation device, if the door opening time is set according to the distance between the destination floor reservation device and the hall, in some cases, a user having a slow walking speed cannot get on the car, or a user having a fast walking speed is kept waiting although any other user is absent.

Also, in the case where the door closing operation can be started by the user's operation in the car as described in Patent Literature 2, in some cases, the elevator car is started without the user having a fast walking speed waiting the boarding of other users. Therefore, there is a possibility that the user having a slow walking speed cannot get on board.

The present invention was made to solve the above-described problems, and an object of the invention is to provide an elevator operating apparatus provided with a destination floor reservation device, which can prevent a user having a slow walking speed from failing to get on an elevator car, and can surely prevent a user from being kept waiting fruitlessly at a boarding floor.

### Solution to Problem

An elevator operating apparatus of the invention is an elevator operating apparatus which comprises a destination floor reservation device from which a user registers the destination floor together with the personal information before getting on an elevator car, car arranging means which arranges the elevator car at a boarding floor when the destination floor is registered from the destination floor reservation device, an input device which is installed at an elevator hall and from which the user who has registered the destination floor from the destination floor reservation device inputs the personal information at the hall, and start interrupting means which causes the elevator car to wait at the boarding floor while the door thereof is open during the time when a person who has not inputted the personal information from the input device is present among the users who have registered the personal information from the destination floor reservation device after the elevator car was arranged at the boarding floor by the car arranging means.

### Advantageous Effects of Invention

According to the present invention, in an elevator provided with a destination floor reservation device, a user having a slow walking speed can be surely prevented from failing to get on an elevator car. Also, a user can be prevented from being kept waiting fruitlessly at a boarding floor.

### BRIEF DESCRIPTION OF DRAWINGS

FIG. 1 is a configuration view of an elevator operating apparatus in a first embodiment according to the present invention.

FIG. 2 is a circuit configuration diagram of the elevator operating apparatus in the first embodiment according to the present invention.

FIG. 3 is a flowchart showing the operation of the elevator operating apparatus in the first embodiment according to the present invention.

### DESCRIPTION OF EMBODIMENTS

The present invention will be described in more detail with reference to the accompanying drawings. Incidentally, in each of the drawings, like numerals refer to like or similar parts and redundant descriptions of these parts are appropriately simplified or omitted.

### First Embodiment

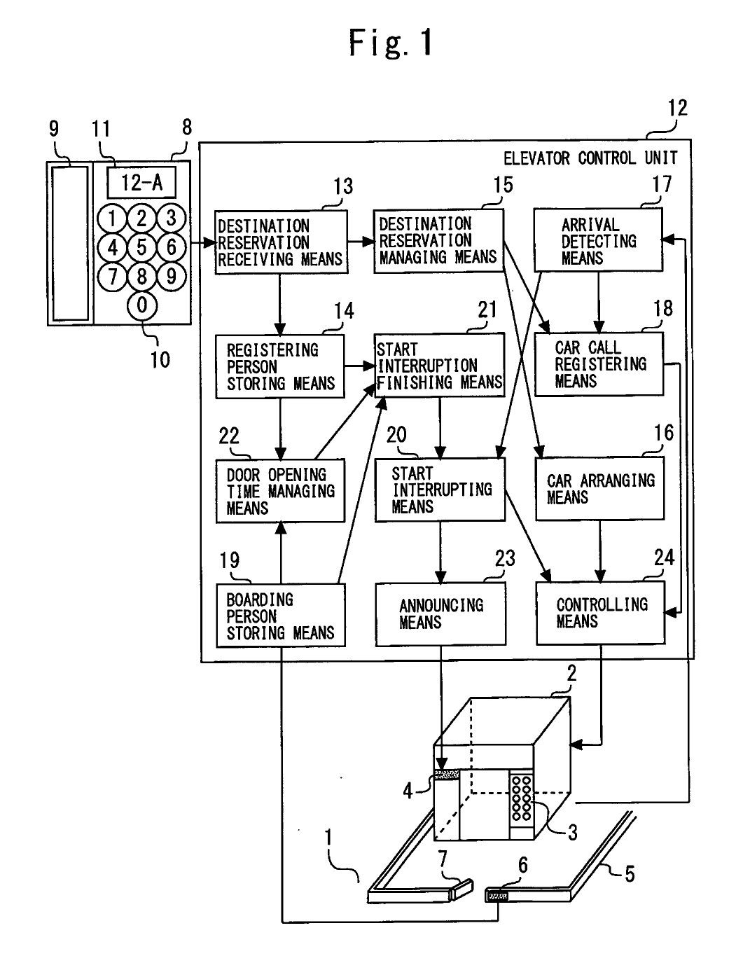

FIG. 1 is a configuration view of an elevator operating apparatus in a first embodiment according to the present invention.

In FIG. 1, reference numeral 1 denotes an elevator hall, and 2 denotes a car moving up and down in an elevator shaft. FIG. 1 schematically shows a state in which the car 2 is stopping at the hall 1. Reference numeral 3 denotes an operating panel in the car 2, which is provided with destination buttons and the like, and 4 denotes an announce device for giving voice guidance to a user in the car 2.

In the elevator hall 1, there are provided a fence 5 surrounding the entrance of elevator, an authentication device 6 for a user to perform personal authentication, and a gate 7 that opens when the personal authentication is performed by using the authentication device 6. That is, unless the gate 7 is opened by the input of personal information to the authentication device 6, the elevator user cannot move from the outside of the fence 5 to the front of elevator door. The authentication device 6 also functions as an input device to which the user inputs his/her personal information at the hall 1.

Reference numeral 8 denotes a destination floor reservation device from which the elevator user registers a destination floor together with the personal information before getting on the car 2. This destination floor reservation device 8 is installed at a place distant from the hall 1, for example, in a passage leading to the hall 1, or at the entrance of the building. FIG. 1 shows one example of the destination floor reservation device 8 which is provided with an authenticating section 9 that is used when the user performs personal authentication, a ten-key pad 10 that is used when the user inputs the destination floor, and an indicator 11 that displays various pieces of information for the user. In the case where the destination floor reservation device 8 configured as described above is installed, the user inputs the personal information into the authenticating section 9 to perform personal authentication, and also operates the ten-key pad 10 to input his/her own destination floor.

The destination floor reservation device 8 may be of any configuration if having a function of registering the personal information and the destination floor. The destination floor reservation device 8 can be realized, besides the device shown in FIG. 1, by a button with a fingerprint matching device, a ten-key pad with a card reader, a security gate, or the like. Also, the destination floor reservation device 8 may be a device in which when the personal authentication is performed on the basis of the inputted personal information, the destination floor of the authenticated person is registered automatically.

Reference numeral 12 denotes a control unit for carrying out the operation control of elevator. This control unit 12 controls the elevator properly based on various pieces of information inputted from the destination floor reservation device 8 and the authentication device 6 so as to prevent the user's failure to get on board and the user's fruitless waiting. To perform such a function, the control unit 12 is provided with various means denoted by reference numerals 13 to 24.

Reference numeral 13 denotes a destination reservation receiving means that receives a call registration instruction sent from the destination floor reservation device 8. When the user inputs the personal information to the destination floor reservation device 8 to perform personal authentication, a call registration instruction is sent from the destination floor reservation device 8 to the destination reservation receiving means 13. The call registration instruction includes, for example, hall information (floor information) corresponding to the destination floor reservation device 8 and the personal information and destination floor information that are registered by the user.

When the destination reservation receiving means 13 receives the call registration instruction, the information about the user who has registered the destination floor from the destination floor reservation device 8 (hereinafter, referred to as a “registering person”) is stored in a registering person storing means 14. Specifically, the registering person storing means 14 stores the personal information of the registering person and the registration time.

Reference numeral 15 denotes a destination reservation managing means that manages the call registration instruction received by the destination reservation receiving means 13. This destination reservation managing means 15 manages the call registration instructions, for example, in the order of registration. Reference numeral 16 denotes a car arranging means that arranges an elevator car at the boarding floor (the floor at which the user registered the destination floor) when the destination floor is registered by using the destination floor reservation device 8. This car arranging means 16 registers the hall call based on the call registration instruction managed by the destination reservation managing means 15, whereby the elevator car is stopped at a predetermined hall 1, and the door opening operation is performed.

Reference numeral 17 denotes an arrival detecting means that detects the arrival of the elevator car at the boarding floor, and 18 denotes a car call registering means that registers the car call. When the arrival detecting means 17 detects that the elevator car has arrived at the boarding floor, the car call registering means 18 registers the corresponding car call based on the call registration instruction managed by the destination reservation managing means 15.

Reference numeral 19 denotes a boarding person storing means that stores the information about a user who has inputted the personal information to the authentication device 6 to perform personal authentication (hereinafter, also referred to a “boarding person”). The boarding person storing means 19 stores the personal information of the boarding person and the time when that information is inputted.

The car call registering means 18 may be configured so that, only when a user has inputted the personal information from the input device 6, it registers the car call corresponding to the destination floor of that user. In this case, when the personal information is stored in the boarding person storing means 19, the car call registering means 18 registers the car call of that user based on the call registration instruction managed by the destination reservation managing means 15 (the destination floor registered from the destination floor reservation device 8 by that user).

Also, reference numeral 20 denotes a start interrupting means that causes the elevator car to wait at the boarding floor while the door thereof is opened under a predetermined condition after the elevator car has been arranged at the boarding floor under the control of the car arranging means 16. This start interrupting means 20 continues the door-opened waiting of the car until a release instruction for releasing the start interruption is received from a start interruption finishing means 21.

The start interruption finishing means 21 outputs the above-described release instruction, for example, when all of the users who have inputted the personal information from the destination floor reservation device 8 to perform personal authentication (corresponding to the registering persons) are authenticated by using the authentication device 6. Specifically, when all of the registering persons stored in the registering person storing means 14 are stored as boarding persons in the boarding person storing means 19, the start interruption finishing means 21 outputs the release instruction. That is, the start interrupting means 20 continues the waiting at the boarding floor while the door is closed during the time when a person who has not inputted the personal information from the input device 6 is present among the users who have registered the personal information from the destination floor reservation device 8.

Considering the case where the user who has registered the destination floor from the destination floor reservation device 8 gives up the use of elevator for some reason, the configuration may be made such that when the waiting time exceeds predetermined time, the release instruction is output from the start interruption finishing means 21. Also, the configuration may be made such that the movement time of each of the users is learned by a door opening time managing means 22, and the waiting time is set for each of the users. In this case, the door opening time managing means 22 manages the time from when the personal information is inputted to the destination floor reservation device 8 to when the personal information is inputted to the authentication device 6 for each of the users based on the contents stored in the registering person storing means 14 and the boarding person storing means 19. The start interruption finishing means 21 properly sets the waiting time for each of the users based on the time managed by the door opening time managing means 22 and outputs the release instruction.

The start interruption finishing means 21 may be configured as a partial function of the start interrupting means 20.

Also, reference numeral 23 denotes an announcing means that controls the announce device 4. The announcing means 23 makes in-car announcement of being waiting any other user during the time when the elevator car is caused to wait at the boarding floor while the door thereof is open by the function of the start interrupting means 20 to prevent the user waiting the start in the car 2 from feeling uneasiness or unpleasantness.

Reference numeral 24 denotes a controlling means that controls various operations of elevator. The controlling means 24 outputs proper operation instructions to an elevator traction machine, a door driving device (both not shown), and the like based on the information inputted from the car arranging means 16, car call registering means 18, the start interrupting means 20, and the like.

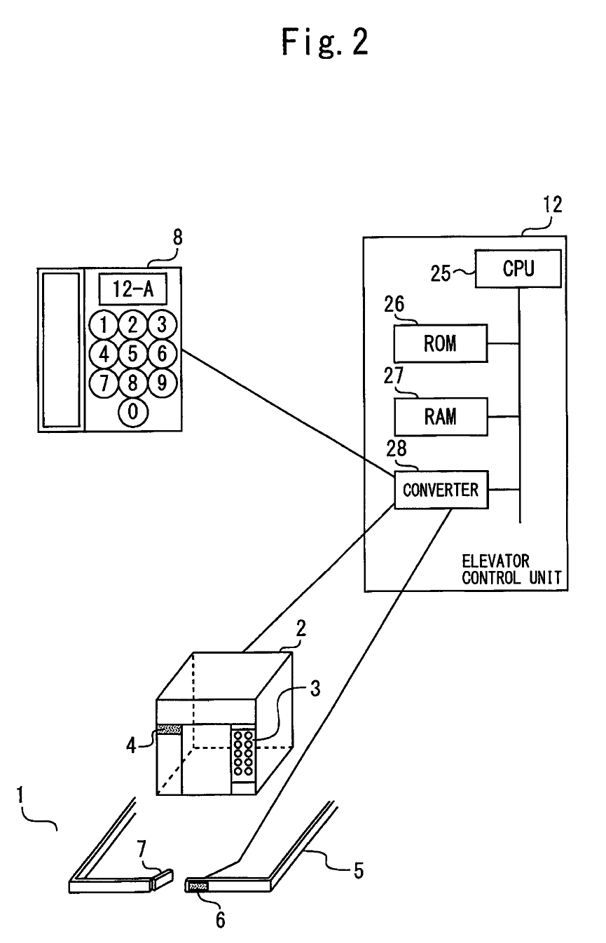

FIG. 2 is a circuit configuration diagram of the elevator operating apparatus in the first embodiment according to the present invention. As shown in FIG. 2, the control unit 12 includes a ROM 26, a RAM 27, and a converter 28 in addition to a CPU 25 consisting of a central arithmetic and logic unit. The ROM 26 is a read-only memory in which operation programs are stored, and the RAM 27 is a memory in which the data necessary for control are stored. Also, the converter 28 is connected with the destination floor reservation device 8 and the authentication device 6, and the operating panel 3 and the announce device 4 provided in the car 2, and the like, and functions to convert the input/output signals.

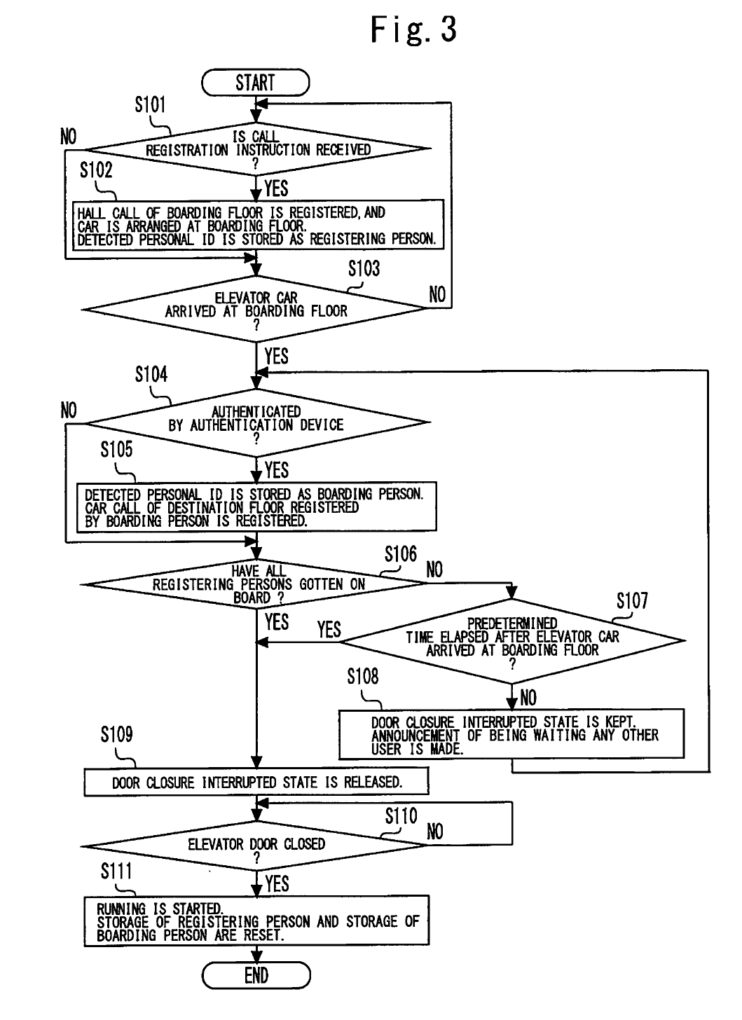

Next, the specific operation of the elevator operating apparatus having the above-described configuration is explained with reference to FIG. 3 as well. FIG. 3 is a flowchart showing the operation of the elevator operating apparatus in the first embodiment according to the present invention. The control program shown in FIG. 3 is loaded in the control unit 12.

In the control unit 12, it is determined whether or not a call registration instruction has been received from the destination floor reservation device 8 by the destination reservation receiving means 13 (S101). If the call registration instruction has been received by the destination reservation receiving means 13, the control unit 12 causes the car arranging means 16 to register the corresponding hall call and arrange the elevator car at the boarding floor, and the destination reservation managing means 15 to store (manage) boarding reservation from the boarding floor to the destination floor. Also, based on the call registration instruction received by the destination reservation receiving means 13, the detected personal information is stored in the registering person storing means 14 as a registering person of the boarding floor concerned (S102).

After the processing in S102, the control unit 12 determines whether or not the elevator car has arrived at the boarding floor (S103). If the arrival of the car 2 is not detected by the arrival detecting means 17, the control unit 12 waits until the arrival of the car 2 is detected unless a new call registration instruction is received. If the arrival of the car 2 is detected by the arrival detecting means 17, the control unit 12 determines whether or not the user who registered the destination floor from the destination floor reservation device 8 has been authenticated by the authentication device 6 (S104). If the control unit 12 confirms the authentication performed by using the authentication device 6 in S104, the car call corresponding to the user authenticated by the authentication device 6 is registered by the car call registering means 18 based on the boarding reservation managed by the destination reservation managing means 15. Also, the personal information detected by using the authentication device 6 is stored in the boarding person storing means 19 as a boarding person (S105).

Next, the control unit 12 determines whether or not all of the registering persons have gotten on the elevator car (S106). Specifically, when all persons stored in the registering person storing means 14 as registering persons are stored in the boarding person storing means 19 as boarding persons, the control unit 12 determines that all of the registering persons have gotten on board. If all or some of the registering persons have not gotten on board, the control unit 12 determines whether or not predetermined time (corresponding to the above-described waiting time) has elapsed after the elevator car arrived at the boarding floor (S107). If at least one of the registering persons has not gotten on board, and the predetermined time has not elapsed after the elevator car arrived at the boarding floor, the control unit 12 causes the elevator car to wait at the boarding floor while the door thereof is open by using the start interrupting means 20, and also makes in-car announcement of being waiting any other user by the announcing means 23 (S108).

On the other hand, if the boarding of all of the registering persons is detected in S106, or if it is determined that the predetermined time has elapsed in S107, in the control unit 12, the start interruption finishing means 21 outputs a release instruction to release the door closure interrupted state (S109). Subsequently, the control unit 12 fully closes the elevator door and starts the running of elevator car to cause the elevator car to respond to the car call. Also, the control unit 12 resets the storage contents of the registering person storing means 14 and the boarding person storing means 19, and deletes the information about the stored registering persons and boarding persons (S110, S111).

In the case where the control proceeds from S107 to S109, the destination call of the user who has not been authenticated by using the authentication device 6 may be registered thereafter to cause the elevator car to respond.

According to the first embodiment of the present invention, unless all of the users who have registered the destination floor from the destination floor reservation device 8 input the personal information from the authentication device 6 when getting on the elevator car, the elevator car does not start from the boarding floor. Therefore, even in the case where the destination floor reservation device 8 is installed at a place distant from the hall 1, the user having a slow walking speed is prevented from failing to get on the elevator car.

Also, when the user who has registered the destination floor from the destination floor reservation device 8 is, for example, one in number, the door closing operation is started immediately after the user has gotten on board, and the elevator car starts from the boarding floor. Therefore, the user does not wait fruitlessly at the boarding floor, and the user does not feel uneasiness or unpleasantness in the car 2.

In the first embodiment, the case where one elevator is present has been described. However, it is a matter of course that this operating apparatus can be applied to a system which group-controls a plurality of elevators. In this case, for example, the authentication device 6 (input device) is installed in front of the door of each of the elevators so that the user can input the personal information from the corresponding authentication device 6 when getting on the elevator car. Also, the registering person storing means 14 and the boarding person storing means 19 are caused to store the registering person and the boarding person for each assigned elevator. When all of the registering persons scheduled to get on a predetermined elevator have gotten on the corresponding elevator car (have inputted the personal information from the corresponding authentication device 6), the start interruption finishing means 21 outputs a release instruction for that elevator to the start interrupting means 20.

### INDUSTRIAL APPLICABILITY

The elevator operating apparatus according to the present invention can be applied to an apparatus in which a user registers his/her destination floor and personal information from a destination floor reservation device before getting on an elevator car.

### REFERENCE SIGNS LIST

1 hall
2 car
3 operating panel
4 announce device
5 fence
6 authentication device
7 gate
8 destination floor reservation device
9 authenticating section
10 ten-key pad
11 indicator
12 control unit
13 destination reservation receiving means
14 registering person storing means
15 destination reservation managing means
16 car arranging means
17 arrival detecting means
18 car call registering means
19 boarding person storing means
20 start interrupting means
21 start interruption finishing means
22 door opening time managing means
23 announcing means
24 controlling means
25 CPU
26 ROM
27 RAM
28 converter

1. An elevator operating apparatus comprising:
a destination floor reservation device from which a user registers the destination floor together with the personal information before getting on an elevator car;
a car arranging device which arranges the elevator car at a boarding floor when the destination floor is registered from the destination floor reservation device;
an input device which is installed at an elevator hall and from which the user who has registered the destination floor from the destination floor reservation device inputs the personal information at the hall; and
a start interrupting device which causes the elevator car to wait at the boarding floor while the door thereof is open during the time when a person who has not inputted the personal information from the input device is present among the users who have registered the personal information from the destination floor reservation device after the elevator car was arranged at the boarding floor by the car arranging device.

2. The elevator operating apparatus according to claim 1, wherein when the time of causing the elevator car to wait while the door thereof is opened exceeds a predetermined waiting time, the start interrupting device closes the door and starts the elevator car from the boarding floor.

3. The elevator operating apparatus according to claim 2, further comprising:
a door opening time managing device which manages the time from when the personal information is registered by using the destination floor reservation device to when the personal information is inputted by using the input device for each of the users, wherein
the start interrupting device sets the waiting time for each of the users based on the time managed by the door opening time managing device.

4. The elevator operating apparatus according to claim 1, further comprising:
a car call registering device which registers a car call to the user who has registered the personal information from the destination floor reservation device when the personal information is inputted to the input device.

5. The elevator operating apparatus according to claim 1, further comprising:
an announcing device which makes in-car announcement of being waiting any other user during the time when the elevator is caused to wait at the boarding floor while the door thereof is open by the start interrupting device.

6. The elevator operating apparatus according to claim 2, further comprising:
a car call registering device which registers a car call to the user who has registered the personal information from the destination floor reservation device when the personal information is inputted to the input device.

7. The elevator operating apparatus according to claim 2, further comprising:
an announcing device which makes in-car announcement of being waiting any other user during the time when the elevator is caused to wait at the boarding floor while the door thereof is open by the start interrupting device.
